(19) United States
(12) Patent Application Publication
(10) Pub. No.: US 2007/0251756 A1
(43) Pub. Date: Nov. 1, 2007

(54) Automotive Steering System

(75) Inventors: Thomas Butschi, Reutigen (CH); Lorenz Zellweger, Thun (CH)

Correspondence Address: BIRCH STEWART KOLASCH & BIRCH, PO BOX 747, FALLS CHURCH, VA, 22040-0747, US

(73) Assignee: CYGNUS AG, Thun (CH)

(21) Appl. No.: 11/662,409

(22) PCT Filed: Sep. 16, 2005
(86) PCT No.: PCT/CH05/00548

§ 371 Date: Mar. 9, 2007

(30) Foreign Application Priority Data
Sep. 17, 2004 (EP) 04405596.0

(51) Int. Cl. B62D 5/04

(52) U.S. Cl. 180/444; 280/93.5

(57) ABSTRACT

The invention relates to an automotive steering system with a variable transmission ratio for a vehicle which is provided with at least one steerable wheel. Said steering system comprises a steering linkage having at least one elongate control rod (40) defining a control rod longitudinal direction, and an elongate working rod (70) defining a working rod longitudinal direction. The automotive steering system further comprises a superposition transmission provided with an actuating drive. Said superposition transmission is effective between the steering rod (40) and the working rod (70). The steering rod (40) can be displaced in the steering rod longitudinal direction under the influence of a steering spindle (20) and a steering gear (30). The working rod (70) can be displaced between the control rod (40) and the working rod (70) in the working rod longitudinal direction under the influence of the displacement of the control rod (40) and a relative displacement initiated by the actuating drive superimposed by means of the superposition drive. The displacement of the working rod (70) is transmitted onto the steerable wheel via a part of the steering gear, thereby steering the wheel. The superposition transmission comprises a nut interacting with the same in the manner of a spindle/nut drive. A first gear section of a gear pair defined by spindle and nut is linked with a first rod of a rod pair defined by the control rod and the working rod. The second gear section of the gear pair is mounted on the second rod so as to rotate in relation to the second rod of the rod pair. The actuating drive is adapted and mounted so as to drive the second gear part to rotate in relation to the second rod.

### TECHNICAL FIELD

The present invention relates to a vehicle steering system with a variable transmission ratio for a vehicle which is provided with at least one steerable wheel, with a steering linkage which has at least one control rod and a working rod, as well as a variable ratio gear unit which is provided with an actuator drive and acts between the control rod and the working rod, the control rod being displaceable in the longitudinal direction of the control rod under the influence of a steering spindle and a steering gearing, the working rod being displaceable in the longitudinal direction of the working rod under the influence of the displacement movement of the control rod and a relative displacement movement between the control rod and the working rod, said relative displacement movement being superimposed on the displacement movement of the control rod by means of the variable ratio gear unit and being initiated by the actuator drive of said variable ratio gear unit, and the displacement movement of the working rod being transmitted to the steerable wheel via part of the steering linkage in order to steer said wheel, the variable ratio gear unit comprising a spindle and a nut which interacts with the latter in the manner of a spindle-nut drive.

### PRIOR ART

In conventional vehicle steering systems, the steering movements which are initiated on a steering handle (for example a steering wheel or a steering rod) by the driver by means via a steering spindle, a steering gearing and a steering linkage are passed onto the steerable vehicle wheels. In this context, a rotary movement of the steering handle about an angle da of rotation is converted overall by the vehicle steering system into a pivoting movement of the steered wheels about a pivoting angle dβ. The transmission ratio of the steering system, (i.e. the transmission ratio between the rotary movement of the steering wheel and the pivoting movement of the steered wheels) is usually considered to be constant in conventional vehicle steering systems even though strictly speaking a slight change in the transmission ratio also already occurs here at large pivoting angles, said change being caused by the geometry of the steering linkage. Despite the slight non-linearities, it is possible to see conventional steering systems as having a linear relationship between the angle dα of rotation of the steering handle and the pivoting angle dβ of the steered wheels.

In addition what are referred to as vehicle steering systems with a variable transmission ratio are known in which, in order to improve the maneuverability at low driving speeds and/or the straight-ahead running properties at high driving speeds a selectively variable transmission ratio is implemented between the angle da of rotation of the steering handle and the pivoting angle dβ of the steered wheels.

EP 0 915 003 A1 (Wandfluh A G) describes a vehicle steering system with a variable transmission ratio which is provided with a mechanical steering gearing which has a high degree of non-linearity between the movements at the gearing input and the movements at the gearing output. Although a variable transmission ratio with a comparatively large difference between the maximum transmission ratio and the minimum transmission ratio is implemented in this steering system by virtue of the specific steering gearing, the possibilities of varying the transmission ratio are restricted because, however, in the same way as conventional steering systems with a constant transmission ratio there is still positive coupling between the steering handle and the steered wheels.

Relatively large possibilities for varying the transmission ratio are provided by steering systems of the type in which further steering movements which are initiated by a variable ratio gear unit provided with an actuator drive are superimposed on the steering movements initiated by the driver. In this context, in each case the steering movement of a steering component which is initiated by the driver by means of the variable ratio gear unit has superimposed on it a further steering movement which is not directly initiated by the driver.

Documents DE 197 50 585 A1 (Deutsches Zentrum für Luft-und Raumfahrt [German Aeronautics and Aerospace Center]) and DE 196 01 826 A1 (Bosch) describe steering systems of this type with a variable ratio gear unit in which in each case a rotary movement of an axle or shaft of the steering system which is initiated by the driver by means of the electromotively driven actuator drive of the variable ratio gear unit has a further rotary movement superimposed on it. In this context, the variable ratio gear unit can be arranged between the steering handle and the steering gearing, in the region of the steering gearing or between the steering gearing and the steered wheels.

The variable ratio gear units which are designed to superpose two rotary movements cause considerable frictional losses and give the driver an unaccustomed steering sensation. For this reason, DE 102 16 130 A1 (BMW) proposes a vehicle steering system with a variable transmission ratio, which system has on each side of the steering gearing of a toothed rack steering system a variable ratio gear unit between the steering gearing and the two steered wheels. The two variable ratio gear units couple the toothed rack in the region of each of its two longitudinal ends to a track rod which is arranged coaxially with respect to the toothed rack, each of the two variable ratio gear units superimposing in each case a further sliding movement in the longitudinal direction of the rod on the sliding movement of the toothed rack which is caused by the steering spindle and the toothed rack gearing. The variable ratio gear units comprise internal spindles which are formed on the toothed rack, control sleeves which interact with said toothed rack and are connected to the track rod by means of an axial joint, as well as rotatable housing parts. The latter each have a curved track with which a pin formed on the control sleeve interacts so that by rotating the housing parts relative to the control sleeves the distances between the toothed rack and control rod can be influenced. The rotary movements are brought about by actuators which engage on levers mounted on the outside of the housings. The variable ratio gear units described in document DE 102 16 130 A1 (BMW) for superimposing two sliding movements give the driver a better steering sensation than the variable ratio gear units for superimposing rotary movements. However, they are structurally costly and problematic in terms of the installation space requirement in the region of the toothed rack.

Even greater possibilities for varying the way in which the transmission ratio is influenced are provided by steering systems which function according to what is referred to as the steering-by-wire principle. In these steering systems, a microprocessor calculates a pivoting angle from a plurality of relevant parameters and said pivoting angle is then transmitted by suitable actuator elements to the steered wheels. In document DE 195 46 94 C1 (Mercedes Benz) a vehicle steering system is described which has a transmission ratio which can be varied in accordance with a characteristic diagram at least as a function of an angle dα of rotation of the steering handle and the driving speed.

Presentation of the Invention

The object of the invention is to present a new concept for a vehicle steering system which belongs to the technical field mentioned at the beginning and has a variable transmission ratio.

The means of achieving the object are defined by the features of the independent claims. According to the invention, a first gearing part (basic part) of a pair of gearing parts formed from the spindle (threaded spindle) and the nut is permanently connected to a first rod of a pair of rods which is formed from the control rod and the working rod, i.e. the first gearing part is rotationally fixed and nondisplaceable with respect to the first rod. In particular, the spindle can even be embodied as an integral component of the first rod. The second gearing part of the pair of gearing parts is mounted on the second rod so as to be rotatable with respect to the second rod of the pair of rods, i.e. the second gearing part can rotate about an axis of rotation which is parallel to the longitudinal direction of the second rod, but is essentially nondisplaceable in the longitudinal direction of the second rod. The actuator drive is finally embodied and arranged in such a way that it can drive the second gearing part to rotate with respect to the second rod. By means of a relative rotary movement between the nut and spindle the two gearing parts are displaced in the longitudinal direction of the spindle in relation to one another. By means of the actuator drive it is thus possible to generate a linear relative displacement movement of the first gearing part (basic part), and thus of the first rod, in the longitudinal direction of the second rod.

As a result of the fact that the actuator drive can be used to drive the second gearing part directly about its axis of rotation, the variable ratio gear unit can be made compact and constructed with a simple mechanism. The gearing is thus structurally simple and thus cost effective and less susceptible to faults.

The spindle/nut drive of the actuator drive is advantageously embodied as a self-locking recirculating ball mechanism, i.e. the nut is a recirculating ball bearing and the spindle is a recirculating ball spindle. An electric motor is advantageously used to drive the second gearing part. Alternatively it is also possible, for example, to employ a hydraulic drive.

The control rod can for example be a rod which is connected to a steering gearing of the vehicle steering system, in particular the toothed rack of a toothed rack steering gearing or a rod which is permanently connected to it. The working rod can be, for example, a track rod or a rod which is permanently connected to it.

The variable ratio gear unit is preferably embodied and arranged in such a way that if there is a failure in the actuator drive it is blocked and the control rod is then nondisplacably connected to the working rod via the variable ratio gear unit. This improves the safety of the vehicle steering system according to the invention in the event of a fault.

According to one advantageous variant of the vehicle steering system according to the invention, the first gearing part of the pair of gearing parts is the nut and the first rod of the pair of rods is the control rod. The nut is therefore permanently attached to the control rod, while the spindle which interacts with the nut is rotatably arranged on the control rod and can be driven by the actuator drive to rotate about its axis of rotation. This arrangement is structurally simple and space saving, and in addition the nut can be embodied as an integral component of the control rod, for example by forming an end-side axial bore on the latter to receive the spindle.

In one alternative embodiment, the nut can be mounted on the working rod while the spindle is connected to the control rod. Further embodiments can also be implemented, wherein in each case one of the gearing parts is rotatable (but axially nondisplaceable) with respect to the assigned rod while the other gearing part is connected permanently (i.e. in a rotationally fixed and axially nondisplaceable manner) to its associated rod. The drive interacts in each case with the rotatable gearing part. It is therefore also conceivable in particular for the nut to be coupled rotatably to the assigned rod, while the spindle is connected to the other rod in a rotationally fixed fashion.

In one advantageous variant of a vehicle steering system according to the invention, the control rod forms the toothed rack of a steering gearing as is customary for conventional toothed rack steering systems. The first gearing part can then be permanently connected to the toothed rack. In particular, the first gearing part can be formed by a nut which is embodied as an integral component of the toothed rack. As a result, overall a particularly simple, compact and cost-effective structure of the vehicle steering system is obtained.

The toothed rack of the steering gearing system can have a regular toothing in order to form a steering gearing with a constant transmission ratio. As an alternative to this it is, however, also possible to use a toothed rack whose toothing is fabricated with a different modulus and angle of engagement in order to form a steering gearing with a variable transmission ratio.

In one advantageous embodiment of the steering system according to the invention the working rod has a cavity in which the control rod is arranged. The axes of the working rod and of the control rod can coincide or be parallel but be offset slightly with respect to one another. As a result the overall space requirement of the variable ratio gear unit and of the steering system is minimized.

The casing of the working rod advantageously has a continuous opening through which the steering gearing can interact with the control rod which is held in the working rod. As a result, the interaction is made possible with a conventional steering gearing in a structurally simple way.

The actuator drive is preferably arranged directly in the cavity of the working rod. The necessary additional installation space for the variable ratio gear unit is thus so small that the steering system according to the invention can be installed or retrofitted without adaptations in most vehicle models. The integrated solution also simplifies installation: for example it may be sufficient (from the mechanical point of view) to replace the existing track rod by the working rod according to the invention with an integrated actuator drive. The operating noise of the actuator drive is highly damped by the arrangement within the working rod so that it is not audible or virtually inaudible in the passenger compartment of the vehicle even with very quiet vehicle engines and without additional sound damping measures.

An actuator drive which is installed inside the working rod advantageously comprises an alternating current electric motor with a high number of poles. An alternating current electric motor with a high number of poles comprises 8 pairs of poles (i.e. 16 poles) or more, and thus permits low rotational speeds with a high torque and has a high efficiency, without using an additional gearing. Suitable motors of this kind which require a small installation space and also otherwise satisfy the requirements and are thus preferably used within the scope of the invention are known from DE 102 40 704 A1 (Tirron Elektronik GmbH). These are alternating current machines with a high number of poles and with a stator and a rotor which is equipped with permanent magnets. One ferrite core which is composed of two ferrite core shells and which contains a central coil former with one or more windings is provided per phase. The axis of the coil former coincides with the shaft axis of a rotor shaft of the rotor. Outside the coil former, a number of ferrite poles are formed by grinding out. The rotor which is separated from the stator by an air gap comprises twice the number of permanent magnets and the rotor shaft, a rotor plate, a rotor sleeve and a permanent magnet holding ring for the permanent magnets. The permanent magnets each have alternating north and south polarity in the axial direction. The same arrangement is set up axially one next to the other for a plurality of phases with a common rotor shaft. The ferrite poles of the individual phases are displaced tangentially by one pole division divided by the number of phases with respect to the permanent magnet poles so that a specific rotational direction is produced together with the phase position of the current. A motor of this kind which is suitable for passenger cars can be fabricated, for example, with an external diameter of only 22 mm.

In order to damp vibrations acting on the working rod from the wheels, a motor receptacle in or on which the actuator drive can be mounted is advantageously arranged in the working rod, the motor receptacle being of elastic design. This can be achieved by fabricating the motor receptacle from an elastic material or with sections made of an elastic material or by providing the motor receptacle with spring means.

Torques and vibrations are transmitted from the steerable or steered vehicle wheel to the working rod. The elastic motor receptacle reduces the further transmission to the control rod. The selection of the spring means can thus allow the reaction of the wheel on the steering handle and thus the configuration of the steering system (sport hard or comfortable damped) to be influenced selectively.

The rotary drive can also comprise a drive motor which is spaced apart from the second gearing part and a rotary drive gearing, the drive motor being coupled via the rotary drive gearing to the second gearing part in order to drive it to rotate with respect to the second rod. The drive motor can be mounted on the first gearing part (basic part) or on any other part of the vehicle steering system or of the vehicle. The rotary drive gearing can, for example, comprise a toothed belt which is driven by the drive motor and drives the nut to rotate about its axis of rotation. As an alternative to a toothed belt drive it is possible, however, for the rotary drive gearing also to comprise a gear wheel mechanism, a chain gear mechanism or some other type of drive gearing which is suitable for driving the second gearing part of the spindle-nut drive to rotate about its axis of rotation. The spaced-apart drive motor is subject to stringent requirements of its overall size, can easily be supplied with power and is easier to cool. However, additional installation space is required for the spaced-apart motor and the transmission to the second gearing part and the installation of the steering system can be somewhat more demanding (for example in retrofits) than in integrated solutions.

In one embodiment of the invention, the working rod is arranged offset from the control rod at a distance transversely with respect to the longitudinal direction of the control rod (or transversely with respect to the control rod or its extension), in particular the working rod and the control rod are arranged offset with respect to one another. As a result, less installation space is required in the region of the control rod. This installation space can then be used for other components of the vehicle steering system and/or of the vehicle. Compared to structures in which the control rod and the working rod are arranged directly next to one another or even coaxially adjacent to one another, this solution permits other degrees of freedom in the implementation of various structural solutions in the region of the control rod. Furthermore, by arranging them offset with respect to one another at least a certain degree of decoupling of the control rod from the working rod is achieved. All the torques and vibrations which are transmitted from the steerable or steered vehicle wheel to the working rod are then no longer transmitted from the working rod on to the control rod. This provides the possibility of making the control rod less solid than in the case of a working rod which is arranged directly at the control rod and coupled directly to it.

With this embodiment of the steering system according to the invention the control rod and the working rod are advantageously arranged parallel to one another (and offset with respect to one another transversely in relation to their longitudinal direction). As a result, the structure of the vehicle steering system according to the invention is simplified. However, it is basically also possible to arrange the control rod and the working rod in a non-parallel fashion with respect to one another.

The variable ratio gear unit and the steering linkage are preferably embodied in such a way that steering angles which are predefined by a rotary position of the steering spindle are influenced by activating the actuator drive for two steerable wheels in the same way as when the rotary position is changed. With a single variable ratio gear unit it is thus possible to influence the steering transmission ratio for both wheels (the two wheel positions always being influenced in the same way as for a corresponding change in the rotary position of the steering wheel). In such an embodiment it is therefore not intended to be able to influence the steering angle of the inner wheel independently of the steering angle of the outer wheel but instead the intention is that the influence on the steering angle will always correspond to a change in the steering transmission ratio. As a result, a steering behavior is obtained which can be learnt quickly and checked satisfactorily. In addition, there is no need for complex adaptation to further components such as, for example, a power steering system.

In order to implement this characteristic of the steering system, the variable ratio gear unit preferably has a single output element which is connected to both wheels exclusively via pivoting joints and rigid connecting elements (that is to say for example via track rods and steering levers).

This connection can be implemented particularly easily if the output element comprises a working rod (track rod) which is embodied in a continuous fashion from a first steering lever of the first wheel to a second steering lever of the second wheel.

According to a further advantageous aspect of the invention, a vehicle steering system for a vehicle which is provided with at least one steerable wheel has a steering handle, for example a steering wheel or a steering rod, which can be activated by the driver and which is coupled to the steerable wheel in order to steer it. In this context, a transmission ratio, which can be changed in accordance with a characteristic diagram at least as a function of the deflection of the steering handle from a straight-ahead position of the steering handle and as a function of the driving speed of the vehicle, is present between an angle of rotation applied to steering handle by the driver and a pivoting angle of the steerable wheel which is brought about as a result via the vehicle steering system. However, the transmission ratio remains essentially constant if both the driving speed is in a central speed region and the deflection of the steering handle from its straight-ahead position is in a limited region about the straight-ahead position, i.e. if both the driving speed is between a lower limiting speed and an upper limiting speed and the deflection of the steering handle from its straight-ahead position is smaller than a limiting deflection angle.

A transmission ratio which is essentially constant in a speed range and/or a deflection angle range is understood in the present context to be a transmission ratio whose value does not change to a greater degree in the specified speed and steering angle range than the value of the transmission ratio of a conventional vehicle steering system (i.e. a vehicle steering system without a variable transmission ratio such as, for example, a toothed rack steering system with regular toothing) in the same deflection angle range. In this sense, changes in the transmission ratio of only a few percent in the entire deflection angle range which can be used in practice for a specific driving speed are also considered as a constant transmission ratio.

In other words, this means that according to this aspect of the invention the transmission ratio remains essentially constant and in all cases in which both the driving speed is in a central speed region between the lower limiting speed and the upper limiting speed and the deflection of the steering handle from its straight-ahead position is in a central angle region bounded on both sides of the straight-ahead position by the limiting deflection angle. The essentially constant transmission ratio in a central speed and deflection angle region ensures that the driver is not surprised by unexpected effects of the vehicle steering system in this parameter range. This improves the safety when driving in the speed and deflection angle range which is used most often. It is clear that this aspect of the invention proves advantageous also for vehicle steering systems with a variable transmission ratio which are not provided with a variable ratio gear unit which acts between a control rod and a working rod which is offset transversely with respect to said control rod.

The lower limiting speed can be in the region between approximately 20 and 50 km/h, in particular be approximately 30 km/h. Driving maneuvers such as, for example parking the motor vehicle on a car park are typically carried out below this limiting speed with a vehicle. For such driving maneuvers a vehicle steering system with a highly progressive steering characteristic is advantageous, i.e. a steering system which becomes increasingly direct as the steering handle is increasingly deflected from its straight-ahead position. In other words, this means that the transmission ratio of such a steering system is substantially larger at large deflection angles of the steering handle than in the region of the straight-ahead position of the steering handle.

For the upper limiting speed, a value between approximately 80 and 150 km/h has proven advantageous, in particular a value of approximately 100 km/h. The upper limiting speed can correspond in particular to the maximum permissible speed in a certain country. This ensures that the region with an essentially constant transmission ratio in the upward direction is exited only at speeds such as typically occur only on race tracks which are separated from the public traffic. The upper limiting speed can, depending on the geometry of the vehicle, be selected in particular as a function of the wheel base of the vehicle to be steered. For the sake of good straight-ahead running it may be desirable to reduce the transmission ratio at all those speeds at which vehicles usually only travel on freeways, that is to say for example speeds above 100 km/h. The vehicle steering system according to the invention permits, by virtue of its design, simple switching over or adaptation of the limiting speeds by virtue of the fact that the controller for the actuator drive is given an appropriate different setting. There is no need for complex mechanical structural work.

The vehicle steering system is preferably also constructed in such a way that, outside the abovementioned central parameter region, changes in the transmission ratio occur continuously as a function of the driving speed and/or the deflection of the steering handle. As a result, abrupt changes in the transmission ratio are avoided. Otherwise, such abrupt changes could surprise the drier and lead to undesired and consequently dangerous steering maneuvers.

According to one preferred embodiment of the invention, a vehicle steering system with a variable transmission ratio which is however constant in a central speed and deflection range has a variable ratio gear unit which is provided with an actuator drive and which acts between a control component and a working component of the steering system. In this context, the control component is movable under the influence of the steering handle and the working component is movable under the influence of the movement of the control component and a relative movement between the control component and the working component, said relative movement being superimposed on said movement of the control component by means of the variable ratio gear unit and being initiated by the actuator drive of said variable ratio gear unit, and the movement of the working component being transmitted to the steerable wheel in order to steer it. The essentially constant transmission ratio in the central speed and deflection range is implemented by virtue of the fact that if both the driving speed is between the lower limiting speed and the upper limiting speed and the deflection of the steering handle from its straight-ahead position is smaller than the limiting deflection angle, the actuator drive is blocked. The blocking of the actuator drive has the effect that no relative movements between the control component and the working component which are initiated by the actuator drive take place.

However, a vehicle steering system with a variable transmission ratio which is however constant in a central speed and deflection range can also be implemented by other designs of vehicle steering systems.

Advantageously, for driving speeds (in particular even all driving speeds) which are lower than the lower limiting speed, the variability of the transmission ratio as a function of the deflection of the steering handle is greater than for driving speeds (in particular even all driving speeds) which are higher than the lower limiting speed. This means that a comparatively large deflection-angle-dependent variability of the transmission ratio is then present in a range with low driving speeds (consequently also referred to as a driving maneuver range). For example, it is thus possible in this speed range for the transmission ratio in the straight-ahead position of the steering handle to have a value between approximately 1:13 and 1:19, in particular a value of approximately 1:16, in which case the transmission ratio increases as the deflection of the steering handle increases, and can reach a value between approximately 1:12 and 1:6, in particular a value of approximately 1:8, given a maximum deflection. The deflection-dependent variability of the transmission ratio preferably also increases in this speed range, i.e. in the maneuvering range) as the driving speed decreases, but advantageously in the entire maneuvering range the deflection-dependent variability is greater than the driving-speed-dependent variability. However, it is also possible to provide for there to be essentially only deflection-dependent variability in the entire maneuvering range, while the variability as a function of the driving speed is negligibly small, or not present, in this speed range.

Furthermore, for driving speeds which are higher than the upper limiting speed (in particular even for all driving speeds) the variability of the transmission ratio as a function of the driving speed is advantageously higher than for driving speeds which are lower than the upper limiting speed (in particular even for all driving speeds). That is to say that in a range with high driving speeds (consequently also referred to as a high speed range) a comparatively large degree of variability of the transmission ratio as a function of the driving speed is present. Thus, for example in this speed range the transmission ratio in the straight-ahead position of the steering handle in the vicinity of the upper limiting speed can have a value between approximately 1:13 and 1:19, in particular a value of approximately 1:16, while as the driving speed increases the transmission ratio in the straight-ahead position increases and can reach a value between approximately 1:20 and 1:30, in particular a value of approximately 1:25, at a maximum driving speed. In this speed range the speed-dependent variability of the transmission ratio preferably increases as the driving speed increases. In the high speed range, the speed-dependent variability is preferably also greater than the deflection-dependent variability in the entire deflection range which cannot all be used at these driving speeds. However, there can also be provision for just one speed-dependent variability of the transmission ratio to be present in the high speed range, while the variability as a function of the deflection of the steering handle is negligibly small or is not present.

Further advantageous embodiments and feature combinations of the invention become apparent from the following detailed description and the entirety of the patent claims.

### BRIEF DESCRIPTION OF THE DRAWINGS

In the drawings used to explain the exemplary embodiment,

FIG. 1 shows a simplified schematic illustration of a vehicle steering system according to a first preferred embodiment of the invention;

FIG. 2 shows a toothed rack of the vehicle steering system from FIG. 1 in a simplified detailed view;

FIG. 3 shows a simplified schematic detailed view of a vehicle steering system according to a second preferred embodiment of the invention;

FIG. 4 shows part of a vehicle steering system according to a third preferred embodiment of the invention in a simplified detailed view;

FIG. 5 shows part of a vehicle steering system according to a fourth preferred embodiment of the invention in a simplified detailed view;

FIGS. 6A, B show part of a vehicle steering system according to a fifth preferred embodiment of the invention in a simplified external view and in a cross section along the axes of symmetry of control rod and of the working rod.

Basically, in the figures identical parts are provided with identical reference symbols.

### WAYS OF IMPLEMENTING THE INVENTION

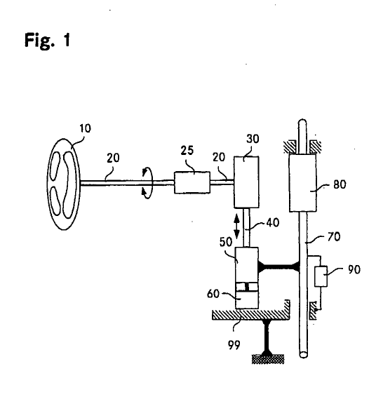

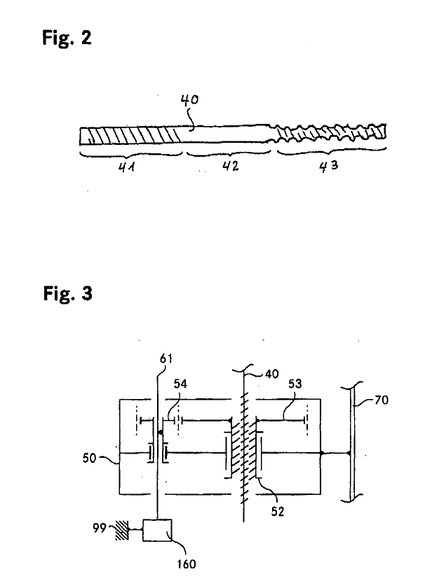

The vehicle steering system illustrated in FIG. 1 has a steering wheel 10 which is permanently connected to a steering spindle 20. Steering movements which are applied to the steering wheel 10 by the driver are transmitted via the steering spindle 20 and via a steering gearing 30 to a rod 40 which is referred to below as control rod 40.

The control rod 40 has a first rod part 41 which is provided with a toothing and in which it acts as a toothed rod 40. The steering gearing 30 is a toothed rack steering gearing. The rotary steering movements which are fed into the steering gearing 30 by the steering spindle 20 are converted by the steering gearing 30 into translatory sliding movements of the control rod 40. The sliding movements displace the control rod 40 in the longitudinal direction of the control rod with respect to the vehicle 99.

Adjacent to the first rod part 41, the control rod 40 has a second rod part 42 with an essentially smooth surface. The second rod part 42 (also referred to as connecting part 42) is adjoined by a third rod part 43 which is provided with an external thread, and in its third rod part 43 the control rod 40 is embodied as a threaded spindle 40 which interacts with a recirculating nut in the manner of a spindle/nut drive.

The recirculating nut is mounted so as to be rotatable about an axis of rotation in a gearing housing 50 of a variable ratio gear unit with respect to the gearing housing 50 and is nondisplacably mounted in the direction of the axis of rotation with respect to the gearing housing 50. The third rod part 43 engages with its external thread in an internal thread, corresponding thereto, on the recirculating nut so that the recirculating nut and the control rod 40 interact in the manner of a spindle/nut drive. A rotary drive which is provided with an electric motor 60 and by means of which the recirculating nut can be driven to rotate about its axis of rotation is also mounted on the gearing housing 50. If the recirculating nut rotates about its axis of rotation, the gearing housing 50 is as a result displaced in the rod longitudinal direction with respect to the control rod 40 owing to the spindle/nut drive formed by the recirculating nut and the control rod 40. Rotation of the recirculating nut thus causes the displacement movement of the control rod 40 which is brought about by the steering spindle 20 and the steering gearing 30 to have superimposed on it a relative displacement movement, brought about by the electric motor 60 and the spindle/nut drive formed from the recirculating nut and the control rod 40, between the gearing housing 50 and the control rod 40.

The gearing housing 50 is permanently connected to a track rod 70 which is arranged parallel to the control rod 40 and offset from it at a distance transversely with respect to the longitudinal direction of the control rod 40 (and thus also transversely with respect to the longitudinal direction of the track rod 70). Owing to the permanent connection to the gearing housing 50, the track rod 70 is displaced together with the gearing housing 50 longitudinally in relation to the track rod 70 (and thus also longitudinally in relation to the working rod 40) with respect to the vehicle 99 if the gearing housing 50 is displaced with respect to the vehicle 99 owing to steering movements initiated by the steering spindle 20 and/or by the electric motor 60. The displacement movements of the track rod 70 are transmitted via a further part of the steering linkage (not illustrated) to two steerable vehicle wheels (not illustrated) in order to steer said wheels.

The electric motor 60 is controlled and supplied with current via a control device (not illustrated). The control device receives measurement signals from a steering spindle sensor 25 which is arranged on the steering spindle 20 and which measures the deflection of the steering spindle 20 from its straight-ahead position and the steering torques which are applied by the driver via the steering wheel 10, a speed sensor (not illustrated) which measures the driving speed, and a displacement sensor 90 which is arranged in the region of the track rod 70 and which measures the displacement of the track rod 70 with respect to the vehicle 99. As a function of the these measurement signals, the control device adjusts the electric current to the electric motor 60 and a servodrive 80 which supports displacement movements of the track rod 70 with respect to the vehicle 99 in the manner of a servodrive of a customary power steering system.

The control device controls the electric motor 60 in such a way that the electric motor 60 is blocked if both the driving speed is between a speed of 30 km/h and 100 km/h and the deflection of the steering wheel 10 from its straight-ahead position is less than 180°. Furthermore, the electric motor 60 is controlled by the control device in such a way for driving speeds below 30 km/h the transmission ratio in the straight-ahead position of the steering wheel is 1:16, and as the deflection of the steering wheel 10 increases it rises to a value of 1:8 at the maximum deflection of the steering wheel 10. At driving speeds above 100 km/h, the electric motor 60 is controlled by the control device in such a way that the transmission ratio in the straight-ahead position drops from a value 1:16 at 100 km/h as the driving speed increases to value of approximately 1:25 at the maximum driving speed. Cars with a relatively large wheel base or in vehicles for racing applications, an upper limiting speed of, for example, 130 km/h, instead of 100 km/h, can be selected.

The vehicle steering system illustrated in FIG. 3 differs from the vehicle steering system illustrated in FIG. 1, by virtue of the fact that the electric motor 160 of the rotary drive for the recirculating nut 52 is not arranged on the gearing housing 50 but rather on the vehicle 99. The electric motor 160 rotates a drive shaft 61 with respect to the vehicle 99 in order to rotate about its shaft axis. The shaft axis of the drive shaft 61 extends parallel to the control rod 40 and to the track rod 70. The drive shaft 61 is led through the center of a gear wheel 54 which can rotate about an axis of rotation which is coaxial to the shaft axis of the drive shaft 61 and is mounted in the gearing housing 50 so as to be nondisplaceable in the longitudinal direction in relation to this axis of rotation. The drive shaft is connected to the gear wheel 54 in a rotationally fixed fashion but so as to be displaceable in the longitudinal direction of the shaft with respect to the gear wheel 54.

The gear wheel 54 intermeshes with a further gear wheel 53 which is permanently connected to the recirculating nut 52 and can rotate together with it about its axis of rotation. Overall, the drive shaft 61 and the two gear wheels 53, 54 form a rotary drive gearing by means of which the electric motor 160 can drive the recirculating nut 52 to rotate about its axis of rotation, the housing 50 of the variable ratio gear unit together with the recirculating nut 52 and the gear wheels 53, 54 can be displaced in the longitudinal direction of the shaft with respect to the electric motor.

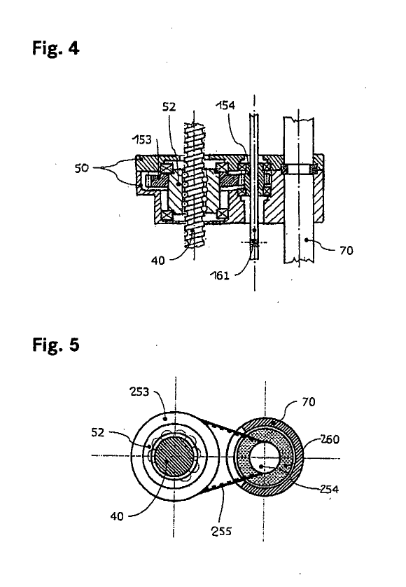

The vehicle steering system illustrated in FIG. 4 differs from the vehicle steering system illustrated in FIG. 3 only in that the drive shaft 161 is arranged between the control rod 40 and the track rod 70, while in the vehicle steering system illustrated in FIG. 3 the control rod 40 is arranged between the drive shaft 61 and the track rod 70. Correspondingly in the vehicle steering system illustrated in FIG. 4 the gear wheel 154 which is connected to the drive shaft 161 is arranged between the gear wheel 153 which is connected to the recirculating nut 62, and the track rod 70, while in the vehicle steering system illustrated in FIG. 3 the gear wheel 53 which is connected to the recirculating nut 52 is arranged between the gear wheel 54 which is connected to the drive shaft 61, and the track rod 70.

The vehicle steering system illustrated in FIG. 5 differs from vehicle steering systems illustrated in the preceding figures in that the electric motor 260 of the rotary drive for the recirculating nut 52 is arranged in a cavity of the track rod 70. The electric motor 260 rotates a gear wheel 254 with respect to the track rod 70 to rotate about an axis of rotation which coincides with the longitudinal axis of the track rod 70 and is thus parallel to the axis of rotation of the recirculating nut 52.

The gear wheel 254 drives, via a toothed belt 255, a further gear wheel 253 which is permanently connected to the recirculating nut 52 and can rotate together with it about its axis of rotation. Overall, the toothed belt 255 and the two gear wheels 253, 254 form a rotary drive gearing by means of which the electric motor 260 which is arranged in the interior of the track rod 70 can drive the recirculating nut 52 to rotate about its axis of rotation.

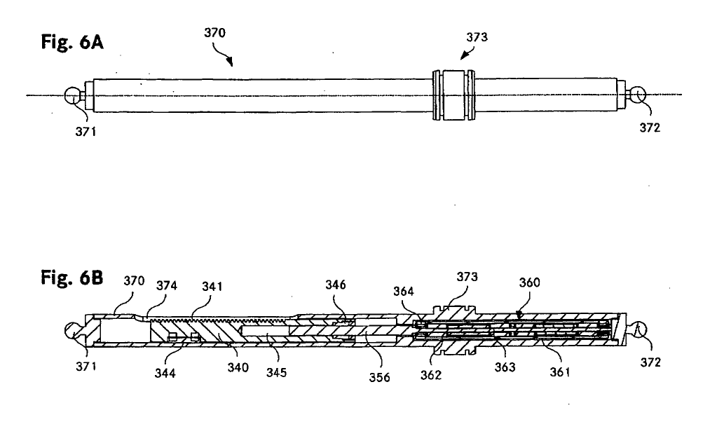

The FIGS. 6A, 6B show part of a vehicle steering system according to a fifth preferred embodiment of the invention. FIG. 6A shows a simplified external view, FIG. 6B shows a cross section along the axis of symmetry of the control rod and the working rod. The track rod 370 (working rod) which has a joint ball 371, 372 at each of its ends, by means of which joint balls 371, 372 it can be coupled to further elements of the steering linkage, for example to the steering levers for the two front wheels of a vehicle is illustrated. The track rod 370 thus extends continuously from the steering lever of the first steerable wheel to the steering lever of the second steerable wheel. On the outside of the track rod 370, a piston section 373 which is part of a hydraulic servodrive (not illustrated in more detail) which is known per se and has the purpose of assisting the steering is formed.

The variable ratio gear unit is now formed within the track rod 370. It comprises a control rod 340 which is mounted in a cavity of the track rod 370 so as to be axially displaceable but fixed in terms of rotation by means of a sliding bearing. The control rod 340 comprises a rod part 341 with a toothing which can interact with a pinion (not illustrated) of the steering shaft in such a way that the control rod 34 is moved to and fro in the axial direction as a function of the rotary position of the steering spindle. A straight toothing or an oblique toothing can be selected for the toothing. By using a variable tooth pitch it is possible to predefine the transmission ratio of the steering angle of rotation of the steering column, in particular progressively. So that the pinion of the steering shaft can engage in the toothing of the control rod 340, the casing of the working rod 370 has a continuous opening 374 in the corresponding section. Opposite the toothing, a press-on bearing 344 is formed in the rod part 341, said press-on bearing 344 comprising spring means which are used to attach a radially movable sliding bearing to the control rod 340. The sliding bearing interacts with the guide within the track rod 370 and suppresses play between the toothing and the pinion of the steering shaft.

At the end of the control rod 340 which lies opposite the rod part 341 with the toothing a receptacle 345 for a spindle 356 of a recirculating ball drive is formed. The receptacle 345 is an axial bore in the control rod 340 whose internal diameter is slightly larger than the external diameter of the spindle 356 so that the latter can be guided within the bore. The recirculating ball bearing 346 is permanently arranged at the open end of the bore, i.e. at the end side of the control rod 340. Said recirculating ball bearing 346 forms a bearing for the spindle 356 on the control rod 340. By varying the length of the control rod 340 it is possible to adapt the damping of the steering, and when a short control rod is used a hard configuration is obtained and when a long control rod is used a more soft configuration is obtained.

In a further cavity of the track rod 370, near to the end of the track rod 370 lying opposite the control rod, an electric motor 360 is accommodated. The latter is held in an elastic motor mount 361 which is made of steel and which surrounds the motor in the manner of a casing and has a damping effect between the track rod 370 and the electric motor 360. If different damping is desired, the motor mount can be fabricated from some other material, for example from a plastic. In order to increase the damping it is possible additionally to use an elastic plate between the rear end side of the electric motor 360 facing the end of the track rod and the termination of the cavity.

The electric motor 360 corresponds to the type which is disclosed in DE 102 40 704 A1 (Tirron Elektronik GmbH) and has a stator 362 with coil formers and a rotor 363 with a series of permanent magnets. The spindle 356 is mounted in a rotationally fixed fashion on the rotor 363. Because the electric motor 360 can generate low rotational speeds with a high torque owing to its design, an additional gearing is unnecessary. A rotary bearing 364 for the spindle 356 is attached in the cavity in the track rod 370 at the front end of the electric motor 360 facing the control rod 340.

The method of functioning of the vehicle steering system in FIGS. 6A, 6B according to the fifth preferred embodiment of the invention is as follows: the rotary movement of the steering spindle is transmitted via the steering gearing to a steering shaft and from there it is converted via the pinion and the toothing in the rod part 341 into a translatory movement of the control rod 340. This movement is firstly transmitted to the track rod 370 and from there to the further elements of the steering linkage (in particular directly to the steering levers) via spindles 356 and the electric motor 360 which is mounted on the track rod 370 in an axially nondisplaceable fashion. A further axial movement can now be superimposed on the axial movement of the control rod 340 generated from the steering spindle if the spindle 356 is rotated relative to the track rod 370 by means of the electric motor 360. As a result of this, the spindle 356 is in fact moved axially with respect to the control rod 340, and the position of the track rod 370 with respect to the steering gearing can thus be influenced independently of the position predefined by the steering spindle.

In addition to this functionality, the known hydraulic servodrive for assisting the steering acts, in particular at low driving speeds, on the steering in a known fashion via the piston section 373. Alternatively, the illustrated track rod with the variable ratio gear unit can also interact with an electric servodrive in order to assist the steering. In this case, the piston section 373 is replaced by a corresponding connecting element.

To summarize, it should be noted that the invention specifies a vehicle steering system which has a variable transmission ratio and is based on a new concept.

1-17. (canceled)

18. A vehicle steering system with a variable transmission ratio for a vehicle (99) which is provided with at least one steerable wheel, with a steering linkage which has at least one control rod (40; 340) and a working rod (70; 370), as well as a variable ratio gear unit which is provided with an actuator drive (60; 160; 260; 360) and acts between the control rod (40; 340) and the working rod (70; 370), the control rod (40; 340) being displaceable in the longitudinal direction of the control rod under the influence of a steering spindle (20) and a steering gearing (30), the working rod (70; 370) being displaceable in the longitudinal direction of the working rod under the influence of the displacement movement of the control rod (40; 340) and a relative displacement movement between the control rod (40; 340) and the working rod (70; 370), said relative displacement movement being superimposed on the displacement movement of the control rod (40; 340) by means of the variable ratio gear unit and being initiated by the actuator drive (60; 160; 260; 360) of said variable ratio gear unit, and the displacement movement of the working rod (70; 370) being transmitted to the steerable wheel via part of the steering linkage in order to steer said wheel, the variable ratio gear unit comprising a spindle (43; 356) and a nut (52; 346) which interacts with the latter in the manner of a spindle-nut drive, characterized in that a first gearing part (43; 346) of a pair of gearing parts formed from the spindle (43; 356) and the nut (52; 346) is permanently connected to a first rod (40; 340) of a pair of rods which is formed from the control rod (40; 340) and the working rod (70; 370), the second gearing part (52; 356) of the pair of gearing parts is mounted on the second rod (70; 370) so as to be rotatable with respect to the second rod (70; 370) of the pair of rods, and the actuator drive (60; 160; 260; 360) is embodied and arranged so as to drive the second gearing part (52; 356) to rotate with respect to the second rod (70; 370).

19. The vehicle steering system as claimed in claim 18, characterized in that the first gearing part of the pair of gearing parts is the nut (346), and in that the first rod of the pair of rods is the control rod (340).

20. The vehicle steering system as claimed in claim 18, characterized in that the control rod (40; 340) has a first rod part (41; 341) with a toothing, the first rod part (41; 341) interacting with the steering gearing, and wherein the control rod (40; 340) has a second rod part (43; 345, 346) which forms the first gearing part.

21. The vehicle steering system as claimed in claim 18, characterized in that the working rod (370) has a cavity in which the control rod (340) is arranged.

22. The vehicle steering system as claimed in claim 20, characterized in that the working rod (370) has a cavity in which the control rod (340) is arranged.

23. The vehicle steering system as claimed in claim 22, characterized in that a casing of the working rod (370) has a continuous opening (374) through which the steering gearing can interact with the control rod (340) which is held in the working rod (370).

24. The vehicle steering system as claimed in claim 21, characterized in that the actuator drive (360) is arranged in the cavity of the working rod (370).

25. The vehicle steering system as claimed in claim 24, characterized in that the actuator drive comprises an alternating current electric motor (370) with a high number of poles.

26. The vehicle steering system as claimed in claim 24, characterized in that a motor receptacle (361) is arranged in the cavity of the working rod (370), the actuator drive (360) being mounted in or on the motor receptacle (361), and the motor receptacle (361) being of elastic design.

27. The vehicle steering system as claimed in claim 18, characterized in that the actuator drive comprises a drive motor (60, 160, 260) which is spaced apart from the second gearing part (52) and is coupled via a rotary drive gearing to the second gearing part (52) in order to drive it to rotate with respect to the second rod.

28. The vehicle steering system as claimed in claim 18, characterized in that the working rod (70) is arranged offset from the control rod (40) at a distance transversely with respect to the longitudinal direction of the control rod.

29. The vehicle steering system as claimed in claim 18, characterized in that the variable ratio gear unit and the steering linkage are embodied and arranged in such a way that steering angles which are predefined by a rotary position of the steering spindle (20) are influenced by activating the actuator drive (60; 160; 260; 360) for two steerable wheels in the same way as when the rotary position changes.

30. The vehicle steering system as claimed in claim 29, characterized in that the variable ratio gear unit has a single output element (70; 370) which is connected exclusively by means of pivoting joints and rigid connecting elements to both the first and the second of two steerable wheels.

31. The vehicle steering system as claimed in claim 30, characterized in that the output element comprises the working rod (70; 370), the latter being embodied in a continuous fashion from a first steering lever of the first steerable wheel to a second steering lever of the second steerable wheel.

32. The vehicle steering system, in particular as claimed in claim 18, for a vehicle which is provided with at least one steerable wheel, with a steering handle (10) which is coupled to the steerable wheel in order to steer it, a transmission ratio, which can be changed in accordance with a characteristic diagram at least as a function of the deflection of the steering handle from a straight-ahead position and as a function of the driving speed, being present between an angle of rotation of the steering handle and a pivoting angle of the steerable wheel, characterized in that the transmission ratio is essentially constant if both the driving speed is between a lower limiting speed and an upper limiting speed and the deflection of the steering handle (10) from the straight-ahead position is smaller than a limiting deflection angle.

33. The vehicle steering system as claimed in claim 32, characterized in that it has a variable ratio gear unit which is provided with an actuator drive (60; 160; 260; 360) and which acts between a control component (40; 340) and a working component (70; 370) of the steering system, the control component (40; 340) being movable under the influence of the steering handle (10), the working component (70; 370) being movable under the influence of the movement of the control component (40; 340) and a relative movement between the control component (40; 340) and the working component (70; 370), said relative movement being superimposed on the movement of the control component (40; 340) by means of the variable ratio gear unit and being initiated by the actuator drive (60; 160; 260; 360) of said variable ratio gear unit, and the movement of the working component (70; 370) being transmitted to the steerable wheel in order to steer it, and the actuator drive being blocked if both the driving speed is between the lower limiting speed and the upper limiting speed and the deflection of the steering handle (10) from the straight-ahead position is smaller than the limiting deflection angle.

34. The vehicle steering system as claimed in claim 32, characterized in that for driving speeds which are lower than the lower limiting speed the variability of the transmission ratio as a function of the deflection is greater than for driving speeds which are higher than the lower limiting speed.

35. The vehicle steering system as claimed in claim 32, characterized in that for driving speeds which are higher than the upper limiting speed the variability of the transmission ratio as a function of the driving speed is higher than for driving speeds which are lower than the upper limiting speed.
